(19) United States
(12) Patent Application Publication
(10) Pub. No.: US 2011/0104224 A1
(43) Pub. Date: May 5, 2011

(54) Textile Finishing For Insect Repellency

(75) Inventors: Werner Mauer, Albersloh (DE); Raymond Mathis, Dusseldorf (DE); Karsten Matz, Essen (DE)

(73) Assignee: COGNIS IP MANAGEMENT GMBH, Dusseldorf (DE)

(21) Appl. No.: 12/917,983

(22) Filed: Nov. 2, 2010

(30) Foreign Application Priority Data
Nov. 5, 2009 (EP) 09013875.1

(51) Int. Cl. A01N 25/24; A01N 53/08; A01P 7/04

(52) U.S. Cl. 424/407; 514/531

(57) ABSTRACT

The invention is drawn to a method of producing a textile flat structure with insect-repellent properties by applying a solution comprising an insect repellent and a binder to a textile flat structure, wherein the binder is a combination of a silicone elastomer of formula (I) and a silicone crosslinker of formula (II), provided that the insect repellent is not microencapsulated, and that the solution is free from acrylate binders. The treated textile flat structures are characterized by excellent washing permanence.

HOR₂SiO—(R₂SiO)ₓ—(RR¹SiO)_{y}—SiR₂OH (I)

HOR₂SiO—(R₂SiO)ₙ—(RR²SiO)ₘ—SiR₂OH (II)

wherein R is CH₃; R¹ is saturated, linear or branched or alicyclic C1-C20 aminoalkyl, which contains one to two primary and/or secondary amino groups; R² is hydrogen; n, m, x, and y, independently are numbers in the range from 1 to 100.

### CROSS-REFERENCE TO RELATED APPLICATIONS

This application claims the benefit of priority under 35 USC §119 of European Patent Application number 09013875.1, filed on Nov. 5, 2009, which is incorporated herein in its entirety.

### FIELD OF THE INVENTION

The invention relates to the use of compositions in the form of a solution comprising an insect repellent and a binder, where the binder is a combination of a specific silicone elastomer and a specific silicone crosslinker.

### BACKGROUND OF THE INVENTION

Malaria is a life-threatening infection which is caused by single-celled organisms (plasmodia) and is transmitted by the Anopheles mosquito indigenous to the tropics and subtropics. Upon infection of a host, the plasmodia attack the red blood cells, where they reproduce. When the pathogens have matured, the blood cell bursts and releases new plasmodia. Destruction of the red blood cells causes a fever. The new plasmodia in turn attack other red blood cells, where they reproduce further. In this way, a cycle is set up which, without medical treatment, in the vast majority of cases leads to death as a result of circulatory collapse or lung edema.

According to an estimate by the World Health Organization (WHO), every year approximately 110 million people suffer from malaria and up to 2.7 million die from the infection. Consequently, malaria is the second most common disease in the world after tuberculosis. As a result of increased travel, tourists are also increasingly becoming ill specifically with the harmful Malaria tropica. About 12,000 cases of Malaria tropica are estimated to occur in Europe every year.

Malaria can always be treated successfully if it is recognized early enough. Malaria prophylaxis is also possible (in particular with the help of quinine compounds, which were previously obtained from the bark of the Cinchona tree), although the risk of pathogen resistance is increasing depending on the region. The best protection against malaria consists in not getting bitten in the first place. Since the dusk- and night-active Anopheles mosquito lives in the vicinity of damp areas and stagnant water, the risk of malaria is particularly high toward the end of the rainy season. In this period, small ponds are formed everywhere in the tropics in which the mosquitoes can lay their eggs. Subsequently, the mosquitoes reproduce in an explosive manner. However, it is not always possible to counter the risk of a malaria infection by moving to high ground for the dry season in the areas affected. The same also applies for other diseases which are exclusively transmitted by insect bites, such as e.g. the West Nile virus or the chikungunya disease known from La Réunion.

Thus, there is a need for compositions with the help of which it is possible to reliably prevent or at least significantly reduce infections as a result of insect bites. Known insect repellents are sesquiterpenes, diethyltoluamide (DEET), ethyl butylacetylaminopropionate (IR3535) and hydroxyethyl isobutyl piperidine carboxylate (Bayrepel), which is also a constituent of the known “Autan” mixture. However, substances from the group of pyrethroids, which are very similar to the toxin of the chrysanthemums and have therefore also acquired their name, are particularly effective. From this group the compound permethrin is known to be particularly effective:

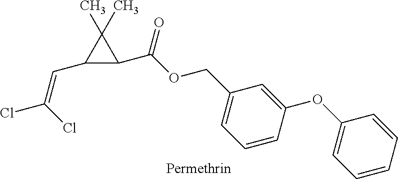

A number of these repellents are applied for example as creams, lotions or sprays directly to the skin. However, the problem is that they are readily washed off by perspiration or are decomposed and thus quickly lose their effectiveness, and further, only those products which are sufficiently skin-compatible and toxicologically acceptable are suitable for this application. The particularly effective natural chrysanthemum extracts such as e.g. pyrethrum are therefore regularly ruled out for these reasons since they are hydrolyzed by water and are decomposed by sunlight.

One alternative to topical application is to finish textiles with insect repellents. Application of the repellents generally takes place by impregnation. However, in practice, it has not proven to be very efficient. In the case of application to tights, for example, the amount of active ingredient is so low on account of the wide-meshed fabric that the repellency per se is already inadequate. In the case of more tightly meshed textiles, i.e. trousers, shirts, T-shirts, but also, for example, tarpaulins, mosquito and camouflage nets, it is observed that the active ingredient is washed out within a very short time or is not available at all for repelling insects because it is absorbed by the fibers. A further disadvantage is that direct application to the fibers or textiles requires the use of a large amount of active ingredients, which necessitates special requirements for health and safety.

EP 1845186 discloses the finishing of fibers and textile flat structures with mixtures of microencapsulated insect repellents and binders. A disadvantage of this solution to the problem is the fact that the insect repellents must firstly be released from the microcapsules by specific processes such as mechanical rubbing in order for them to be available.

EP 1598475 B1 describes a method for producing textile flat structures with insect-repelling properties, where a solution which comprises an insecticide and a binder is applied to a textile flat structure, with the proviso that the insecticide is permethrin and that the solution is admixed with a combination of an acrylate binder and a silicone elastomer in order to improve the retention of the permethrin during successive washes of the textile flat structure. The specific binder combination used in EP 1598475 B1 comprises acrylate binder; this has the disadvantage that as a result textiles have a considerable tendency toward stiffening, especially if, as disclosed in the specification EP 1598475 B1, relatively large amounts of acrylates are used. The wear comfort of the textiles is considerably limited as a result.

EP 1845186 describes another method employing encapsulated insecticides.

### DETAILED DESCRIPTION OF PREFERRED EMBODIMENTS

It was a first object of the present invention to apply insect repellents, in particular permethrin, to textiles in a form such that the insect repellents are reliably fixed to the surface of the textiles, in particular clothing textiles, without the assistance of microcapsules. In other words, the aim was to provide a different technical solution to that described in the above-cited EP 1845186, in which the repellents are located within microcapsules and it is simply the microcapsules which are fixed to the textile surface. By contrast, it is the case for the present invention that the insect repellents are definitively not located in microcapsules, but are to be fixed to the textile surface as they are.

It was a further object that the textiles finished with insect repellents should have good washing permanency. The technical solution to the stated problems that is to be developed should moreover avoid the use of acrylate binders because, as explained above, a certain tendency toward stiffening of the textiles is inherent in these.

The invention first provides a method of producing textile flat structures with insect-repelling properties, where a solution (S) is applied to a textile flat structure, where the solution (S) comprises an insect repellent (IR) and a binder (B),

where the binder (B) used is a combination of
a silicone elastomer (b1) of the formula (I)

HOR₂SiO—(R₂SiO)ₓ—(RR¹SiO)_{y}—SiR₂OH (I)
in which: R═CH₃; R¹=a saturated alkyl group having 1 to 20 carbon atoms, which may be linear or branched or alicyclic and which contains one to two amino groups, where the amino groups may be primary and/or secondary, x and y, independently of one another, are numbers in the range from 1 to 100 and preferably from 1 to 20
and
a silicone crosslinker (b2) of the formula (II)

HOR₂SiO—(R₂SiO)ₙ—(RR²SiO)ₘ—SiR₂OH (II)
in which: R═CH₃; R²=hydrogen; n and m, independently of one another, are numbers in the range from 1 to 100 and preferably from 1 to 20,

where the additional proviso applies that the insect repellent (IR) is not present in microcapsules and that the solution (S) is free from acrylate binders.

It is evident from investigations by the applicant that textile flat structures, in particular clothing textiles, which have been finished in accordance with the method of the invention are characterized by excellent washing permanency, that thus the retention of the insect repellent during successive washing of the textile flat structure is quite exceptional. It has been found that after a large number of washes (50 washes, see experimental section), the washing permanency in the case of the method according to the invention was more favorable than for the method according to the prior art (for this purpose, the above-cited specification EP 1598475 B1 (Utexbel) was used).

Another aspect of the invention is directed to textile flat structures with insect-repelling properties obtained by applying a solution (S) to a textile flat structure, where the solution (S) comprises an insect repellent (IR) and a binder (B), with the proviso that the binder (B) is a combination of a silicone elastomer (b1) of the aforementioned formula (I) and a silicone crosslinker (b2) of the aforementioned formula (II), and where the additional proviso applies that the insect repellent (IR) is not present in microcapsules and that the solution (S) is free from acrylate binders.

Within the context of the present invention, the expression “textile flat structures” includes both textile flat structures as such, and also fibers which can be used for producing textile flat structures. Consequently, the expression “textile flat structures” serves to simplify the language.

The invention further provides the use of compositions in the form of a solution (S) comprising an insect repellent (IR) and a binder (B), with the proviso that the binder (B) is a combination of a silicone elastomer (b1) of the aforementioned formula (I) and a silicone crosslinker (b2) of the aforementioned formula (II), and where the additional proviso applies that the insect repellent (IR) is not present in microcapsules and that the solution (S) is free from acrylate binders, for the finishing of textile flat structures.

### The Insect Repellent (IR)

Suitable insect repellents which can be used within the context of the present invention in the form of microcapsules for the finishing of fibers and textiles include, without limitation, sesquiterpenes, diethyltoluamide (DEET), ethyl butylacetylaminopropionate (IR3535), hydroxyethyl isobutyl piperidine carboxylate, and, in particular, pyrethroids and mixtures thereof.

Typical examples of pyrethroids are, without limitation, 5-benzyl-3-furylmethyl (+)-cis-(1R,3S,E)-2,2-dimethyl-3-(2-oxo-2,3,4,5-tetrahydrothiophenylidenemethyl)cyclopropanecarboxylate, 6-chloropiperonyl 2,2-dimethyl-3-(2-methylpropenyl)cyclopropanecarboxylate, acrinathrin, allethrin, bifentrin, bioresmethrin, cismethrin, cyclethrin, cycloprothrin, cyfluthrin, cyhalothrin, cypermethrin, cyphenotrin, deltamethrin, dimethrin, empenthrin, esfenvalerate, fenfluthrin, fenpropathrin, fenvalerate, flucythrinate, flumethrin, fluvalinate, furethrin, halfenprox, imiprothrin, methyl cis/trans-3-(2,2-dichlorovinyl)-2,2-dimethylcyclopropane-1-carboxylate and in particular permethrin and mixtures thereof.

In one preferred embodiment, the insect repellent (IR) is permethrin.

### The Solution (S)

There are per se no limitations with regard to the nature of the solution (S). However, the solution (S) is preferably an aqueous solution, dispersion or emulsion.

The amount of insect repellent (IR) in the aqueous solution (S) is preferably in the range from 1 to 300 g/l and in particular in the range from 10 to 250 g/l.

The amount of binder (B) in the aqueous solution (S) is preferably at least 10 g/l and in particular at least 30 g/l.

In this connection, the weight ratio of silicone elastomer (b1) and silicone crosslinker (b2) is preferably in the range from 5:1 to 100:1.

### The Textile Flat Structures

There are no limitations per se with regard to the nature of the textile flat structures. It is possible to use any material which is used in textile technology. There is also no limitation with regard to the chemical nature of the fibers on which these textile flat structures are based. Thus, all customary natural and synthetic materials, and also mixtures thereof, are suitable, but in particular cotton, polyamides, polyester, viscose, polyamide/Lycra, cotton/Lycra and cotton/polyester.

In one preferred embodiment, the textile flat structures are clothing textiles, particular preference being given to those clothing textiles which are in direct contact with the skin or which are generally intended to protect against insect bites, for example underwear, shirts, trousers, T-shirts, uniforms, and mosquito and camouflage nets.

In one preferred embodiment, the insect repellent (IR) is permethrin, the solution (S) is an aqueous solution and the textile flat structures are clothing textiles.

### The Binders (B)

As is generally known, binders are polymeric, film-forming substances. The binder (B) of the invention comprises a combination of a silicone elastomer (b1) and a silicone crosslinker (b2). In this connection, the limiting condition applies, that solution (S) is free from acrylate binders.

### Silicone Elastomers (b1)

Within the context of the present invention, the silicone elastomers (b1) used are substances of the formula (I):

HOR₂SiO—(R₂SiO)ₓ—(RR¹SiO)_{y}—SiR₂OH (I)

in which:
R═CH₃;
R¹=a saturated alkyl group having 1 to 20 carbon atoms, which may be linear or branched or alicyclic and which contains one to two amino groups, where the amino groups may be primary and/or secondary,
x and y, independently of one another, are numbers in the range from 1 to 100 and preferably from 1 to 20.

Aminoethylaminopropyl and aminopropyl groups are particularly preferred as radicals R¹.

Particularly preferred compounds (b1) are those crosslinkable aminosiloxanes that are present e.g. in the commercial product COGNIS 3001-A®, from the applicant.

The substances (b1) are crosslinkable substances, i.e. those which can be crosslinked by adding other substances but which are themselves not crosslinkers, i.e. are not crosslinking substances. Accordingly, the substances (b1) are different from the substances (b2), which do have crosslinking properties.

### Silicone Crosslinker (b2)

Within the context of the present invention, the silicone crosslinkers (b2) used are substances of the formula (II):

HOR₂SiO—(R₂SiO)ₙ—(RR²SiO)ₘ—SiR₂OH (II)

in which:
R═CH₃;
R²=hydrogen;
n and m, independently of one another, are numbers in the range from 1 to 100 and preferably from 1 to 20.

Since the radical R² is hydrogen, the compounds (II) are highly reactive siloxane compounds (“H-polydimethylsiloxanes”), which constitute crosslinking substances. Therefore, the compounds (b2) are therefore different from the compounds (b1).

### Applying a Solution (S) to a Textile Flat Structure

The solution (S) can in principle be applied to the textile flat structures to be finished by any method known to the person skilled in the art. Thus, for example, textile flat structures can be impregnated with aqueous solutions of insect repellent (IR) and binder (B) by the so-called absorption method, which can be carried out for example in a standard commercial washing machine or in a dyeing apparatus customary in the textile industry. Preferably, a so-called forced application can be carried out, in which the substrates to be finished are drawn through an immersion bath which comprises insect repellent (IR) and binder (B) and where the application is then carried out by means of a press under pressure. This is also known as a padding application.

### EXAMPLES

Substances and Materials Used:

COGNIS 1008-P®: aqueous permethrin emulsion from Cognis with a permethrin concentration of 5%.

COGNIS 3001-A®: aqueous aminosiloxane emulsion from Cognis (aminosiloxane belongs to the group of elastomers b1)

COGNIS 3002-A®: aqueous H-polydimethylsiloxane emulsion from Cognis (H-polydimethylsiloxane belongs to the group of crosslinkers b2)

COGNIS 6004-B®: wetting agent, Cognis

ACRONET 285 AM®: acrylate copolymer, consisting of: MMA, butyl acrylate and N-methylolacrylamide, Pulcra Chemicals

Textile material: cotton/polyester (50/50) fabric, 210 g/m², camouflage print

Laboratory padder, Mathis

Laboratory tenter, Mathis

### Textile Finishing

### Example 1

A cotton/polyester military fabric with camouflage print, having an areal weight of 210 g/m² was impregnated on the padder. Firstly, using water plus 5 g/l of the wetting agent COGNIS 6004-B®, the liquor absorption of the military fabric was determined in order to then calculate the concentration of the treatment liquor according to the target overlays specified in the example.

The liquor absorption was 50%, i.e. 1 kg of material absorbed 0.5 kg of water. Correspondingly, the concentration of the liquor had to be prepared such that e.g. for a target overlay of 15% of COGNIS 1008-P®, 300 g/l of COGNIS 1008-P® were used in the liquor. A concentration of 15% of COGNIS 1008-P® and 2% COGNIS 3001-A® based on the textile weight was established; consequently, the liquor comprised 300 g/l of COGNIS 1008-P® and 40 g/l of COGNIS 3001-A® and 5 g/l of wetting agent COGNIS 6004-B®.

A textile sample of DIN size A5 was treated with the liquor on the laboratory padder. The liquor absorption was controlled before/after padding through weight determination.

The textile sample was then dried and/or fixed in the laboratory tenter for 3 minutes at 150° C.

### Example 2

As example 1, but using an amount of 5% ACRONET 285 AM® instead of an amount of 2% 3001-A.

### Example 3

As example 1, but additionally using an amount of 5% ACRONET 285 AM®.

The use amounts of examples 1 to 3 are summarized again in table 1 below:

TABLE 1
Comparative experiments

| | Example 1 | Example 2 | Example 3 |
|---|---|---|---|
| Permethrin emulsion | 15% | 15% | 15% |
| 1008-P | | | |
| 3001-A | 2% | | 2% |
| ACRONET 285 AM ® | | 5% | 5% |
| COGNIS 6004-B ® | 5 g/l | 5 g/l | 5 g/l |

Drying/fixing for 3 min at 150° C.

### Example 4

As example 1, but instead of an amount of 2% 3001-A, an amount of 4% 3001-A was used in combination with 0.15% 3002-A.

The use amounts of example 4 are again summarized in table 2 below:

TABLE 2
Experiment according to the invention

| | Example 4 |
|---|---|
| Permethrin emulsion 1008-P | 15% |
| 3001-A | 4% |
| 3002-A | 0.15% |
| COGNIS 6004-B ® | 5 g/l |

Drying/fixing for 3 min at 130° C.

Application-Related Investigations

The textiles finished according to examples 1-3 (comparative example) and example 4 (example according to the invention) were investigated as to washing permanency. The washes were carried out in accordance with ISO 6330 at 40° C. with phosphate-free ECE detergent. The content of permethrin in the textiles was determined analytically at the start (i.e. after 0 washes, shown in tables 3 and 4 by 0 W), after 25 washes (shown in tables 3 and 4 by 25 W) and after 50 washes (shown in tables 3 and 4 by 50 W) (extraction with acetone/acetonitrile, evaluation by GC/MS). The results are given in tables 3 and 4 below.

TABLE 3
Comparative experiments

| | Permethrin content in % |
|---|---|
| Example 1/0 W | 0.643 |
| Example 2/0 W | 0.632 |
| Example 3/0 W | 0.563 |
| Example 1/25 W | 0.138 |
| Example 2/25 W | 0.279 |
| Example 3/25 W | 0.261 |
| Example 1/50 W | 0.047 |
| Example 2/50 W | 0.155 |
| Example 3/50 W | 0.164 |

TABLE 4
Experiment according to the invention

| | Permethrin content in % |
|---|---|
| Example 4/0 W | 0.533 |
| Example 4/25 W | 0.252 |
| Example 4/50 W | 0.179 |

Comparing in particular the permethrin content of the finished textiles according to example 3 (comparison according to EP 1598475 B1) and example 4 (according to the invention) after 25 and 50 washes, then the corresponding values (drop from 0.563 to 0.261 to 0.164 compared to a drop from 0.533 to 0.252 to 0.179) reveal that according to the invention slightly to significantly better results are achieved (permethrin content after 25 washes of 47.3% instead of 46.4% compared to the original permethrin content before the washing; and furthermore: permethrin content after 50 washes of 33.1% instead of 29.1% compared to the original permethrin content before the washing).

In the case of example 4 according to the invention, the soft feel was additionally considerably improved; in contrast to this, the use of acrylate in the comparative example (example 3) led to a stiffening of the textile.

What is claimed is:

1. A method of producing a textile flat structure with insect-repellent properties, comprising the step of applying a solution comprising an insect repellent and a binder, to a textile flat structure, wherein said binder comprises:
(1) a silicone elastomer of formula (I):
HOR₂SiO—(R₂SiO)ₓ—(RR¹SiO)_{y}—SiR₂OH (I)
wherein R is CH₃; R¹ is saturated, linear or branched or alicyclic C1-C20 aminoalkyl, which contains one to two primary and/or secondary amino groups, x and y, independently are numbers in the range from 1 to 100,
and
(2) a silicone crosslinker of formula (II):
HOR₂SiO—(R₂SiO)ₙ—(RR²SiO)ₘ—SiR₂OH (II)
wherein R is CH₃; R² is hydrogen; n and m, independently are numbers in the range from 1 to 100,
to form a treated textile flat structure which shows insect-repellent properties,
provided that said insect repellent is not microencapsulated, and that said solution is free from acrylate binders.

2. The method of claim 1, wherein said insect repellent comprises permethrin, said solution comprises an aqueous solution, dispersion or emulsion, and said textile flat structure comprises clothing textiles.

3. A textile flat structure with insect-repellent properties, obtained by a method comprising the step of applying a solution comprising an insect repellent and a binder, to a textile flat structure, with the proviso that said binder comprises a combination of a silicone elastomer of formula (I):
HOR₂SiO—(R₂SiO)ₓ—(RR¹SiO)_{y}—SiR₂OH (I)
wherein R is CH₃; R¹ is saturated, linear or branched or alicyclic C1-C20 aminoalkyl, which contains one to two primary and/or secondary amino groups, x and y, independently are numbers in the range from 1 to 100,
and a silicone crosslinker of formula (II):
HOR₂SiO—(R₂SiO)ₙ—(RR²SiO)ₘ—SiR₂OH (II)
wherein R is CH₃; R² is hydrogen; n and m, independently are numbers in the range from 1 to 100,
provided that said insect repellent is not microencapsulated, and that said solution is free from acrylate binders.

4. A method of providing insect resistance to a textile flat structure, comprising the step of applying a solution comprising an insect repellent and a binder, to a textile flat structure, wherein said binder comprises:
(1) a silicone elastomer of formula (I):
HOR₂SiO—(R₂SiO)ₓ—(RR¹SiO)_{y}—SiR₂OH (I)
wherein R is CH₃; R¹ is saturated, linear or branched or alicyclic C1-C20 aminoalkyl, which contains one to two primary and/or secondary amino groups, x and y, independently are numbers in the range from 1 to 100,
and
(2) a silicone crosslinker of formula (II):
HOR₂SiO—(R₂SiO)ₙ—(RR²SiO)ₘ—SiR₂OH (II)
wherein R is CH₃; R² is hydrogen; n and m, independently are numbers in the range from 1 to 100,
to form a treated textile flat structure, provided that said insect repellent is not microencapsulated, and that said solution is free from acrylate binders,
wherein said treated textile flat structure shows insect-repellent properties.
